(19) United States
(12) Patent Application Publication
(10) Pub. No.: US 2012/0079687 A1
(43) Pub. Date: Apr. 5, 2012

(54) Earbud Cord Stays

(75) Inventor: Jeff INGRAM, Portland, OR (US)

(73) Assignee: Nike, Inc., Beaverton, OR (US)

(21) Appl. No.: 13/323,907

(22) Filed: Dec. 13, 2011

Related U.S. Application Data
(63) Continuation of application No. 12/432,843, filed on Apr. 30, 2009.

(51) Int. Cl. F16G 11/00

(52) U.S. Cl. 24/3.1

(57) ABSTRACT

A cord stay attachable to a garment in order to guide the cord from an electronic device to ear buds or other listening devices for on or over the ear and to maintain the cord against the garments

### RELATED APPLICATION

This application is a continuation of U.S. patent application Ser. No. 12/432,843 filed Apr. 30, 2009, pending, entitled Earbud Cord Stay.” The above mentioned application is incorporated herein by reference in its entirety.

### FIELD OF THE INVENTION

The invention relates to a cord stays attachable to garments.

### BACKGROUND OF THE INVENTION

MP3 players, IPOD devices, cell phones, and other electronic devices which play music or other audio have become very prevalent. Many of these devices require earbuds, headphones, or other listening devices in order to listen to music, audio books, and the like. Generally a cord is attached to the electronic device and to the earbuds or headphones.

Often the cord becomes tangled or gets in the way of the user resulting in the earbuds, for example, being pulled from the ears, the cord pulled out of the electronic device, or the cord getting caught on something else. Hence clips have been designed to hold the cord against clothing, for example. However, the clips are generally bulky as demonstrated in US Publication 2002/0020045.

It would be beneficial to have a clip system for cords that are attachable to a garment or other substrate but is not bulky, complicated, or expensive to produce.

### BRIEF SUMMARY OF THE INVENTION

Aspects of the invention are directed to a cord stay attachable to a garment in order to guide the cord from an electronic device to ear buds or other listening devices for on or over the ear and to maintain the cord against the garments.

### BRIEF DESCRIPTION OF THE DRAWINGS

FIG. 1 shows a cord stay attached to a garment in accordance with one aspect of the invention.

FIG. 2A shows a front view of a cord stay in accordance with an aspect of the invention.

FIG. 2B shows a side view of the cord stay of FIG. 2A.

FIG. 3A shows a front view of a cord stay in accordance with another aspect of the invention.

FIG. 3B shows a side view of the cord stay of FIG. 3A.

FIG. 3C shows a front view of areas cut from the cord stay of FIG. 3A.

FIG. 4A shows a front view of a cord stay in accordance with another aspect of the invention.

FIG. 4B shows a side view of the cord stay of FIG. 3A.

FIG. 4C shows a front view of areas cut from the cord stay of FIG. 3A.

FIG. 5 shows a front view of a cord stay in accordance with another aspect of the invention.

FIG. 6 shows a front view of a cord stay in accordance with another aspect of the invention.

### DETAILED DESCRIPTION OF THE INVENTION

Aspects of the present invention are directed to cord stays for garments or other substrates in order to guide the cord from an electronic device to ear buds or other listening devices for on or over the ear and to maintain the cord against the garments. For ease of discussion, the invention will be described in terms of attaching to a garment, but the cord stay may be attached to any suitable substrate such as gym bags, fanny packs, wrist or arm bands, and the like.

The garment may be any suitable garment such as shirts, blouses, pants, jackets, coats, undergarments, athletic apparel, and the like. One or more cord stays may be used on any garment. The cord stay may be attached inside or outside the garment.

The cord stay holds the cord against the garment. The cord stay may or may not allow movement of the cord through the stay. Under stress, the cord stay will easily release the cord to prevent accidents, for example.

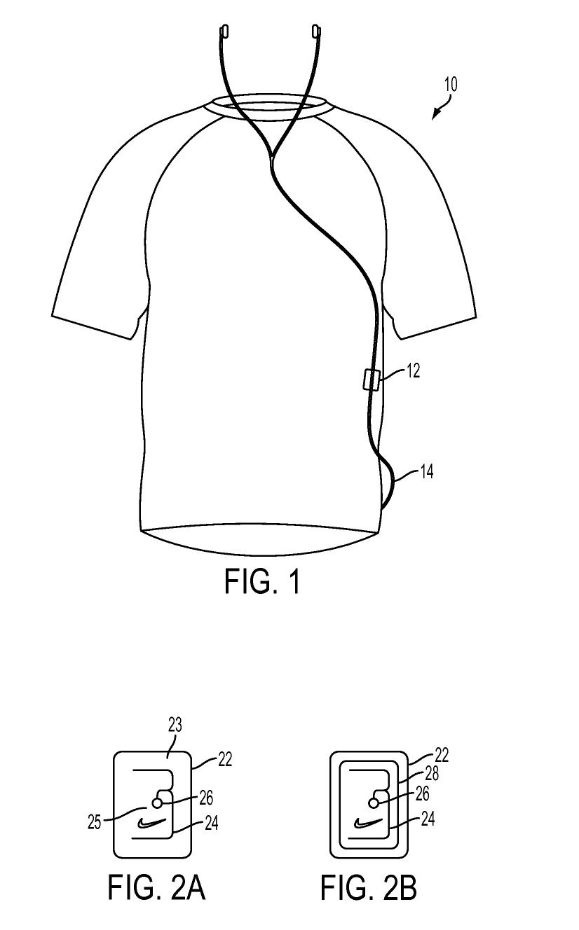

FIG. 1 illustrates a shirt having a single cord stay. The cord stay 12 is attached outside the garment 10. A cord 14 is attached to an electronic device, not shown, travels through the cord stay 12 and ends at ear buds 16. When not in use, the cord stay lays flat.

The cord stay in accordance with the present invention may be of any suitable shape and size. Turning to FIGS. 2A-2B, the cord stay is a generally flat planar thin material. The thin material avoids adding bulkiness or weight to the garment and is unobtrusive to the user. A suitable thickness includes about 0.5 mm to about 4 mm, such as about 1 to about 2 mm. As noted, the cord stay may be of any suitable shape such as rectangular (including square), round, or trapezoidal, as non-limiting examples.

Turning to FIG. 2A, a rectangular cord stay 22 is formed from a flat planar material. The interior of the material is cut to form a “frame” 23 and a “door” or “flap” 25 which splays opens to allow the cord underneath the flap. As shown in FIG. 2A, the flap 25, formed by internal cut shape 24, splays out. Thus, the flap is movable between an open position wherein the flap is extended out of the plane of the planar substrate and a closed position wherein the flap is in the same plane as the planar substrate. The flap may have a continuous slit that defines three sides of a rectangular shape. The fourth side of the flap may be attached to the frame. A pinch point is created between the bottom of the flap 25 and frame 23 of the cord stay 22 when the cord is placed under the flap thus pinching the cord (as shown in FIG. 1).

The internal cut shape 24 may be made by any suitable means and may be a die cut or laser cut for example. A small circular (or oval) area 26 may be cut in the flap to provide a stress relief to prevent the cord from tearing the cord stay. In addition, the small circular area may allow the cord to be more easily adjusted in the cord stay. In the aspect of FIG. 1, the cord is pinched in the slit at the bottom of the flap and then travels under the cord stay (between the cord stay and garment) and then out through the circular area 26.

The corners of the frame of the rectangular-shaped cord stay me be beveled to prevent the corners from turning up.

The cord stay of FIG. 2A may be attached to the garment by stitching as shown in FIG. 2B. The stitches 28 may follow the perimeter or frame 23 of the cord stay 22 as shown in FIG. 2B. Any suitable stitch pattern may be used.

Any other suitable means may be used to attach the cord stay to the garment such as a strong glue, a hook and loop fasteners, or staples. As the cord stays are unobtrusive, a permanent means such as sewing is likely desired.

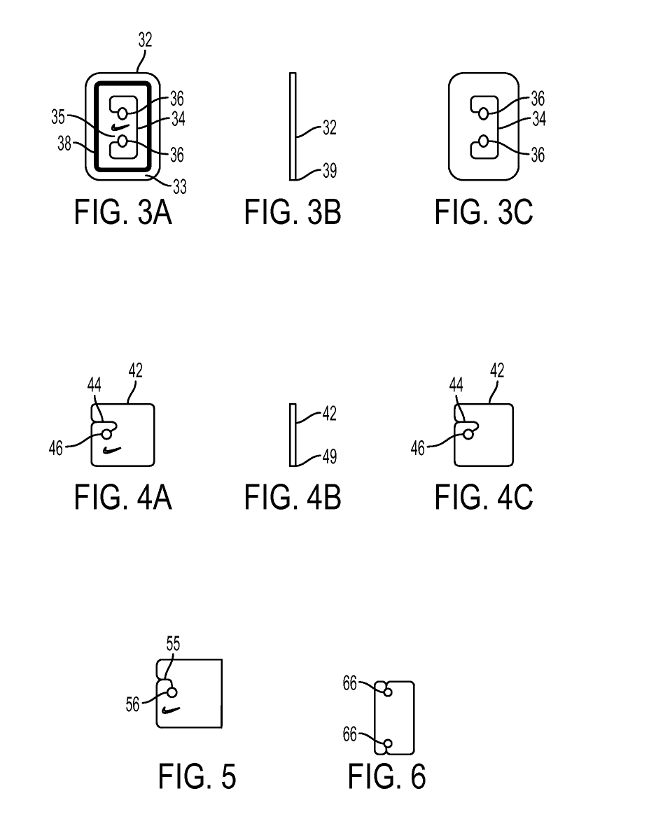

FIGS. 3A-3C show another aspect of the invention. FIG. 3A shows cord stay 32 having an internal cut shape 34 having two small circular (or oval) areas 36 for passage of the cord through the cord stay. Similar to the embodiment of FIG. 2, the internal cut shape 34 forms a flap 35 within a frame 33. Stitches 38 hold the cord stay against the garment. The stitches are made in the frame 33 portion of the cord stay.

FIG. 3B shows a side view of the cord stay having beveled edges 39. FIG. 3C shows the knockout or cut areas of the cord stay. The cord is attached by inserting under the flap 35 from the right side and maneuvered until the cord passes in through one hole 36 and out though the other hole 36. FIG. 3C illustrates the internal cut shape 34 and circular areas 36 of the cord stay.

FIGS. 4A-4C show another aspect of the invention. In this case the cord stay 42 is a flag label which is attached at one side to a garment such as in the side seam. As shown in FIG. 4A, a single cut 44 is made in the cord stay 42. The cut 44 ends in a small circular (or oval) hole 46. FIG. 4B shows a side view of the cord stay having beveled edge 49. FIG. 4C shows the knockout or cut areas 44 of the cord stay. The cord is attached by inserting through the cut on the left side until the cord passes through the single hole. FIG. 5 A is similar to 4A except the cut 44 curves before ending ast the small circular hole 56.

FIG. 6A shows another aspect of a cord stay that is a flag label having small circular (or oval) holes 66 at the top and bottom.

The cord stay includes a flexible and resilient material that will retain its original shape after being flexed. The material may be made from any suitable material such as a thermoplastic polyurethane or silicone. The thickness of the cord stay may be 0.5 to 4 mm, generally about 1 to about 2 mm. The cord stay may be of any suitable shape and dimensions. The length of the cord stay may be between 10 and 50 mm, generally 20-30 mm or 10 to 20 mm. The width may between 10 and 50 mm, generally 10-20 mm.

The electronic device may be placed in a pocket of the garment or worn on a belt or carried in any other suitable manner. The cords or wires are removably connected to the cord stays.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A garment comprising a cord stay attached thereto, wherein the cord stay comprises:
a planar substrate and
a first aperture in the planar substrate which defines a flap;
wherein the flap is movable between an open position wherein the flap is extended out of the plane of the planar substrate and a closed position wherein the flap is in the same plane as the planar substrate; and
wherein the cord stay maintains a cord against the garment.

2. The garment according to the claim 1, wherein the cord stay further comprises at least a second aperture, wherein the second aperture is positioned in the flap.

3. The garment according to the claim 2, wherein at least a portion of the second aperture extends to an edge of the flap so that a cord is insertable into the aperture.

4. The garment according to the claim 2, wherein the first aperture at least partially defines the second aperture.

5. The garment according to the claim 2, wherein the second aperture is circular or oval.

6. The garment according to the claim 2, wherein the cord stay further comprises at least a third aperture, wherein the third aperture is positioned in the flap.

7. The garment according to the claim 6, wherein at least a portion of the third aperture extends to an edge of the flap so that a cord is insertable into the aperture.

8. The garment according to the claim 6, wherein the first aperture at least partially defines the third aperture.

9. The garment according to the claim 6, wherein the third aperture is circular or oval.

10. The garment according to the claim 6, wherein the third aperture is positioned substantially directly below the second aperture.

11. The garment according to the claim 1, wherein first aperture includes a continuous slit that defines at least three side of a rectangular shape.

12. The garment according to the claim 11, wherein the flap is attached to the planar substrate along a fourth side of the rectangular shape.

13. The garment according to the claim 1, wherein first aperture does not extend to an outer edge of the planar substrate so that the flap defined by the first aperture is defined within an interior of the planar substrate.

14. The garment according to the claim 1, wherein the cord stay has a thickness from about 0.5 to about 4 millimeters.

15. The garment according to the claim 1, wherein the cord stay has a thickness from about 1 to about 2 millimeters thick.

16. The garment according to the claim 1, wherein the cord stay has a length from about 10 to about 50 mm and a width from about 10 to about 50 millimeters.

17. The garment according to the claim 1, wherein the cord stay has a length from about 20 to about 30 mm and has a width from about 10 to about 20 millimeters.

18. The garment according to the claim 1, wherein the cord stay has a length between 10-20 mm and has a width between 10-20 millimeters.

19. The garment according to claim 1, wherein the cord stay is attached to the garment by glue, hook and loop fasteners, staples, or stitches.

20. The garment according to claim 1, wherein the cord stay is sewn to the garment along at least a single edge of a perimeter of the cord stay.

21. The garment according to the claim 1, wherein the cord stay includes a flexible and resilient material that will retain its original shape after being flexed.

22. The garment according to the claim 21, wherein the flexible and resilient material is thermoplastic polyurethane or silicone.

23. A garment comprising a cord stay attached thereto, wherein the cord stay comprises:
a planar substrate; and
a first aperture in the planar substrate wherein at least a portion of the first aperture extends to an edge of the planar substrate so that a cord is insertable into the aperture;
wherein the cord stay maintains the cord against the garment.

24. The garment according to the claim 23, wherein the first aperture includes a circular or oval portion defined within the interior of the perimeter of the planar substrate, and a slit that extends between circular portion and the edge of the planar substrate.

25. The garment according to the claim 24, wherein the cord stay further comprises at least a second aperture.

26. The garment according to the claim 25, wherein the second aperture includes a circular or oval portion defined within the interior of the perimeter of the planar substrate, and a slit that extends between circular portion and the edge of the planar substrate.

27. The garment according to the claim 26, wherein the second aperture is positioned substantially directly below the first aperture.

28. The garment according to the claim 27, wherein the slit of the first aperture and the slit of the second aperture extend to a same edge of the planar substrate.

29. The garment according to the claim 28, wherein the slit of the first aperture and the slit of the second aperture extend to different edges of the planar substrate.

30. A method for securing a cord to a garment comprising:
providing a cord stay including
a planar substrate; and
a first aperture in the planar substrate wherein at least a portion of the first aperture extends to an edge of the planar substrate so that a cord is insertable into the aperture.
securing the cord stay to the garment such that the cord stay maintains a cord against the garment.

31. The method for securing a cord to a garment according to claim 30, wherein securing the cord stay includes sewing the cord stay to the garment.

32. The method for securing a cord to a garment according to claim 31, wherein securing the cord stay to the garment includes sewing the cord stay to the garment along at least a single edge of a perimeter of the cord stay.

33. The method for securing a cord to a garment according to claim 32, wherein securing the cord stay to the garment includes sewing the cord stay to the garment along a perimeter of the cord stay.

34. The method for securing a cord to a garment according to claim 30, wherein securing the cord stay to the garment includes attaching the cord stay to the garment with hook and loop fasteners.
